(19) United States
(12) Patent Application Publication
(10) Pub. No.: US 2026/0068876 A1
(43) Pub. Date: Mar. 12, 2026

(54) COMPOSITION

(71) Applicant: ASPIRE TECHNOLOGY GROUP LTD, St Albans (GB)

(72) Inventor: Gary Brierley, St Albans (GB)

(73) Assignee: ASPIRE TECHNOLOGY GROUP LTD, St Albans (GB)

(21) Appl. No.: 19/319,209

(22) Filed: Sep. 4, 2025

(30) Foreign Application Priority Data
Sep. 6, 2024 (EP) 24199066.2

(51) Int. Cl. A01N 25/30; A01N 25/02; A01N 37/02; A01N 43/16

(52) U.S. Cl. CPC A01N 25/30; A01N 25/02; A01N 37/02; A01N 43/16

(57) ABSTRACT

The present invention concerns an aqueous composition having numerous properties that are advantageous to the agricultural and food and drink industries.

### FIELD OF INVENTION

The present invention concerns an aqueous composition having numerous properties that are advantageous to the agricultural, food and drink and other industries.

### BACKGROUND

Growing global population, global warming and regulatory resistance to agricultural chemicals has placed an ever-increasing pressure on global crop production. The United Nations estimated that 2.4 billion people experience moderate or severe food insecurity globally in 2022, based on the 2023 edition of State of Food Security and Nutrition in the World. The report also identifies that doubling agricultural productivity and ensuring sustainable food production are key factors in improving food security, improving nutrition and promoting sustainable agriculture.

The loss of crops to disease, pests and weathering are major obstacles to agricultural productivity. Agricultural research has provided technologies for addressing some of these problems, but existing technology has severe limitations. For example, considerable effort and investment has led to a range of pesticides to prevent, extinguish or repel pests. However, widespread pesticide use can lead to domestic animal contaminations and deaths, loss of natural antagonists to pests, pesticide resistance, Honeybee and pollination decline, losses to adjacent crops, fishery and bird losses and contamination of groundwater. Similar concerns surround many fungicides. Soil fertility is affected by the death or damage to microorganisms caused by pesticides. Further, some pesticides induce immunotoxicity in humans which may lead to immunosuppression, hypersensitivity (allergies) and autoimmune diseases. The same types of problems plague the widespread use of fungicides to prevent the loss of crops to disease.

Weathering by wind is a major problem for agricultural production that cannot be easily addressed with pesticides or fungicides.

More recent attempts to provide biocidal compositions for use in crop protection have been unsatisfactory. For example, US-2020/0008422 A1 relates to the use of diallyl sulfides in a biocidal compositions. One possible source of diallyl sulfides is garlic extracts. The compositions are assessed for their storage stability and use against pest creatures such as mites, worms and spiders, but there is no evidence to suggest the compositions would be effective against harmful organisms. As shown in the Examples section below, the present invention is orders or magnitude more effective against harmful microorganisms.

The inventor has considered these and other problems and has surprisingly found that the present invention can address these and other needs.

### SUMMARY OF INVENTION

The present invention concerns an aqueous composition having numerous properties that are advantageous to the agricultural and food and drink industries. The composition is a colloid or a suspension, in each instance the aqueous component forming the continuous phase. The water content is optionally 20 to 95 wt. %, 50 to 95 wt. %, 70-95 wt. % or 80-90 wt. % based on the weight of the aqueous composition.

The aqueous composition comprises one or more of dimethyl glutarate, one or more dialkyl esters, one or more surfactants, one or more essential oils and/or one or more sugar esters.

When dimethyl glutarate is present, it is optionally present in the amount of 5 to 50 wt. % based on the weight of the aqueous composition, optionally 5 to 40 wt. %, 10 to 35 wt. % or 20 to 30 wt. %. When one or more dialkyl esters are present, they are optionally present in the amount of 0.5 to 40 wt. % based on the weight of the aqueous composition, optionally 1 to 30 wt. %, 5 to 25 wt. % or 10 to 15 wt. %. When one or more surfactants are present, they are optionally present in the amount of 1 to 25 wt. % based on the weight of the aqueous composition, optionally 2 to 20 wt. %, 4 to 18 wt. % or 6 to 15 wt. %. The one or more surfactants optionally comprise one or more glucosides, optionally one or more of a carpryl glucoside (D and/or L), a lauryl glucoside (D and/or L) and a coco glucoside (D and/or L). When one or more essential oils are present, they are optionally present in the amount of 1 to 40 wt. % based on the weight of the aqueous composition, optionally 2 to 30 wt. %, 4 to 20 wt. % or 6 to 15 wt. %. The one or more essential oils are optionally one or more of cedarwood essential oil, cloverleaf essential oil, garlic essential oil, geranium essential oil, lavender extract, lemongrass essential oil, linden extract, peppermint essential oil, peppermint extract, rosemary extract, sage extract, thyme extract, thyme white, thymol valerian extract, and witch hazel extract. When the one or more sugar esters are present they are optionally selected from sucrose esters such as sucrose stearate, sucrose distearate, sucrose dilaurate, sucrose palmitate or combinations thereof. Preferably the sugar ester is sucrose stearate or sucrose distearate, which are commercially available derivatives of stearic acid. The sugar-based ester may be present in an amount of 1 to 45 wt. % based on the weight of the aqueous composition, preferably 2 to 35 wt. %, 3 to 25 wt. %, 4 to 15 wt. %, 0.1 to 7 wt. %, 0.5 to 5 wt. % or 1 to 3 wt. % based on the weight of the aqueous composition.

The aqueous composition can further comprise a film-forming binder, such as a binding polymer. The film-forming binder is preferably a natural substance or derived from a natural substance, such as a natural wax or a carnuba wax. When present, the film-forming binder can be present in the amount of 0.5-5 wt. % based on the weight of the aqueous composition, optionally 0.5-4 wt. %, 0.75-3.5 wt. % or 1-3 wt. %

The present invention further extends to the production and use of the aqueous composition.

### DETAILED DESCRIPTION OF THE INVENTION

Throughout this document, the disclosure of a compositional range (e.g. weight range) of a genus also directly and unambiguously applies to each sub-genus and each individual member of the genus. For example, the one or more dialkyl esters are optionally present in a total amount of 1 to 45 wt. % based on the weight of the aqueous composition, preferably 2 to 35 wt. %, 3 to 25 wt. % or 4 to 15 wt. % based on the weight of the aqueous composition. Preferred dialkyl esters include dialkyl esters of succinic acid such as dimethyl succinate. Therefore, the reader should directly and unambiguously understand that the weight ranges also disclose dialkyl esters of succinic acid in a total amount of 1 to 45 wt. % 2 to 35 wt. %, 3 to 25 wt. % or 4 to 15 wt. % based on the weight of the aqueous composition. The reader should directly and unambiguously understand that the weight ranges also disclose dimethyl succinate in an amount of 1 to 45 wt. % 2 to 35 wt. %, 3 to 25 wt. % or 4 to 15 wt. % based on the weight of the aqueous composition.

### Components and Properties of the Aqueous Composition

The present invention concerns an aqueous composition in the form of a colloid or a suspension. A colloid is a homogeneous non-crystalline substance consisting of large molecules or ultramicroscopic particles of one substance dispersed through a second substance. Colloids include gels, sols, and emulsions; the particles do not settle, and cannot be separated out by ordinary filtering or centrifuging like those in a suspension. A suspension is a composition in which solid particles are dispersed in a continuous liquid phase.

The aqueous component forms the continuous phase in which other substances are dispersed and/or suspended. Water can be present in varying amounts provided that a sufficient amount of water is present to form a continuous phase. The water content is optionally 20 to 95 wt. %, 50 to 95 wt. %, 70-95 wt. % or 80-90 wt. % based on the weight of the aqueous composition. The water can be fresh water or saline water and typically has a pH of 6-8, 6.5-7.5 or 7.

The structure of the colloid can be evaluated by light-scattering techniques that are familiar to a person operating in this technical field. For example, dynamic light scattering can be used to detect the size of a colloidal particle by measuring how fast they diffuse. This method involves directing laser light towards a colloid. The scattered light will form an interference pattern, and the fluctuation in light intensity in this pattern is caused by the Brownian motion of the particles. If the apparent size of the particles increases due to them clumping together via aggregation, it will result in slower Brownian motion. This technique can confirm that aggregation has occurred if the apparent particle size is determined to be beyond the typical size range for colloidal particles. For example, many aqueous compositions of the present disclosure are o/w emulsions.

The structure of the suspension can be evaluated by light-scattering techniques that are familiar to a person operating in this technical field. For example, as with colloids, suspended particle size can be assessed using dynamic light scattering to determine mean particle size and size distribution, for example.

In addition to the aqueous continuous phase, the aqueous compositions of this disclosure contain further components. The aqueous composition comprises one or more of dimethyl glutarate, dimethyl succinate, one or more surfactants, one or more essential oils and one or more sugar esters.

The aqueous compositions comprise dimethyl glutarate, which is a commercially available chemical. It is optionally present in the amount of 5 to 50 wt. % based on the weight of the aqueous composition, optionally 5 to 40 wt. %, 10 to 35 wt. % or 20 to 30 wt. %. Without wishing to be bound by theory, dimethyl glutarate might contribute to the success of the aqueous composition by serving as a calcium releaser. In more detail, it is envisaged that dimethyl glutarate helps the composition to act on calcium ionic bonds present in the membranes of organisms targeted by this composition (bacteria, fungi). Calcium is essential for cell integrity and metabolism and also plays a key role in viral infection and fungi metabolism. Calcium also plays an important role in bacterial biofilm formation, helping to strengthen and stabilize the biofilm matrix. Biofilms are particularly difficult to remove because a biofilm matrix mediates cellular adhesion to surfaces and neighbouring cells, leading to the development of three-dimensional biofilm structures. A biofilm matrix also forms the immediate environment for resident bacteria, retains water, nutrients, and extracellular enzymes, and so protects bacteria from disinfectants, antibiotics, environmental stresses, and the host immune system. It is envisaged that the combination of components present in the aqueous composition interacts with the calcium ionic bonds in a bacterial membrane and/or biofilm matrix, helping to reduce surface tension and structural integrity.

The aqueous composition comprises one or more dialkyl esters, optionally esters of an acid selected from succinic acid, carbonic acid, or adipic acid. The term “dialkyl ester” refers to a compound derived from the esterification of a carboxylic acid with an alkyl alcohol. As such a dialkyl ester contains an ester group (RCOOR′) formed between a carboxylic acid (RCO₂H), preferably an organic carboxylic acid, and an alkyl alcohol (R′OH). Preferably dialkyl refers to dimethyl, diethyl, dipropyl, dibutyl or a mixture of methyl, ethyl, propyl or butyl groups such as methyl and ethyl ester groups. Preferably, the dialkyl ester is dimethyl succinate, dimethyl carbonate, or dimethyl adipate. Most preferably the dialkyl ester is dimethyl succinate. The one or more dialkyl esters are optionally present in the amount of 0.5 to 40 wt. % based on the weight of the aqueous composition, optionally 1 to 30 wt. %, 5 to 25 wt. % or 10 to 15 wt. %. Without wishing to be bound by theory, dialkyl esters might contribute to the success of the aqueous composition by serving to cross biological membranes, become incorporated into cells in tissue culture and metabolized by the TCA cycle. This leads to the formation and elimination of reactive oxygen species. For the purposes of this disclosure, although dimethyl glutarate is formally a dialkyl ester, it is considered a separate category of component to the other dialkyl ester(s). For example, dimethyl glutarate is not factored in when calculating the amount of the dialkyl ester component because the dialkyl ester component is separate to the dimethyl glutarate component. Likewise, for the purposes of this disclosure, the dialkyl ester component is not intended to cover sugar esters, which are conceptually a separate class of component within the bounds of this disclosure.

The aqueous compositions comprise one or more surfactants. Surfactants, also known as surface active agents, are chemical compounds that decrease the surface tension or interfacial tension between two liquids, a liquid and a gas, or a liquid and a solid. These suspensions help to stabilise the colloid or suspension. The one or more surfactants are optionally present in the amount of 1 to 25 wt. % based on the weight of the aqueous composition, optionally 2 to 20 wt. %, 4 to 18 wt. % or 6 to 15 wt. %. The one or more surfactants optionally comprise one or more glucosides. The one or more surfactants may comprise sugar-derived surfactants, for example the one or more surfactants may comprise a glycoside or combination of glycosides. Glycosides refer to compounds which contain a sugar molecule bound to another molecule via a glycosidic bond. A glycosidic bond is often formed between a hemiacetal or hemiketal group of a sugar molecule (or saccharide) and the hydroxyl group of another molecule such as an alcohol. Sugar esters are therefore excluded from this definition and so the skilled person will understand that the one or more surfactants do not include sugar esters or dialkyl esters. Glycosides may for example include glucosides, fructosides, sucrosides or lactosides. Preferably, the one or more surfactants comprise a glucoside such as an alkylglucoside or an alkylpolyglucoside. For example, the surfactant may comprise capryl glucoside, lauryl glucoside, coco glucoside or combinations thereof. Glucosides are preferred because glucose-derived substances are easily taken up or absorbed and metabolised by bacteria. Glucosides are also biodegradable. It is envisaged that glucoside-based surfactants attract microorganisms towards the formulation due to the sugar component of the compounds, leading to interaction of the microorganisms with the active ingredient(s) and subsequent eradication. The one or more surfactants optionally comprise one or more of a carpryl glucoside (D and/or L), a lauryl glucoside (D and/or L) and a coco glucoside (D and/or L).

The aqueous compositions comprise one or more essential oils. Essential oils are concentrated hydrophobic liquids containing chemical compounds from plants that are readily volatile at room temperature. Essential oils are also known as volatile oils, ethereal oils, aetheroleum, or simply as the oil of the plant from which they were extracted, such as oil of clove. An essential oil is essential in the sense that it contains the essence of the plant's fragrance—the characteristic fragrance of the plant from which it is derived. Essential oils are generally extracted by distillation, often by using steam. Other processes include expression, solvent extraction, sfumatura, absolute oil extraction, resin tapping, wax embedding, and cold pressing.

When essential oils are steam distilled from plant matter, water is boiled and steam passes through the organic material which imparts the volatile components into the steam, on cooling these precious components separate into an Essential Oil which can be collected.

Cold pressed essential oils are often obtained from citrus fruits. The extraction of CP (Cold-Pressed) essential oils from citrus fruits involves a specific method that captures the aromatic essence without exposing it to excessive heat or solvents. This process ensures the preservation of the natural qualities and fragrance of the citrus fruits. During cold-pressing, the peels are compressed and squeezed to release the essential oil.

There are several different machines which can perform this operation, the machine used can depend on the location of the factory or the type of fruit being processed. It is also the case that Juice is often extracted alongside the Essential Oil as part of the same process. No heat or chemical solvents are used in this method, allowing for a pure and unadulterated extraction.

Once the essential oil is extracted, it is typically separated from any remaining liquid, such as juice or water, through decantation or centrifugation. The Oil is then often chilled for a number of weeks in order to separate out waxes resulting in a clean usable raw material.

The resulting CP essential oil obtained from citrus fruits is highly concentrated, fragrant, and rich in the characteristic aroma of the specific citrus variety. It can be used in a wide range of applications, including flavour & fragrance formulations, aromatherapy, and cosmetic products, offering a fresh and invigorating scent that captures the essence of the citrus fruit.

The present invention can also use absolutes to form part of the essential oil component. Absolutes are made by extracting the plant material with organic solvents which are then distilled off to leave a thick paste known as a concrete. The waxes that make the concrete so viscous are then removed, leaving the absolute. This complex process ensures the preservation of the aromatic properties of the plant material, resulting in a highly potent and aromatic raw material that can be utilised in the flavour and fragrance industries. To obtain the Absolute, the concrete undergoes a second extraction using a polar solvent, typically ethanol. The polar solvent selectively dissolves the aromatic components present in the concrete, separating them from the non-aromatic substances. This extraction is typically performed through maceration or percolation methods, allowing for maximum extraction efficiency. After the extraction, the solvent is removed from the mixture using distillation or evaporation techniques, leaving behind the concentrated aromatic extract known as the absolute. The absolute is characterized by its intense aroma and high concentration of aromatic compounds, making it a valuable ingredient in perfumery, cosmetics & flavours.

The one or more essential oils are optionally one or more of cedarwood essential oil, cloverleaf essential oil, garlic essential oil, geranium essential oil, lavender extract, lemongrass essential oil, linden extract, peppermint essential oil, peppermint extract, rosemary extract, sage extract, thyme extract, thyme white, thymol valerian extract, and witch hazel extract.

The one or more essential oils are optionally present in the amount of 1 to 40 wt. % based on the weight of the aqueous composition, optionally 2 to 30 wt. %, 4 to 20 wt. % or 6 to 15 wt. %.

It is important to use absolute or concentrated essential oils in the present aqueous composition. If other types of essential oil are use, such as a non-absolute essential oil, in a material amount, then it becomes necessary to include organic solvents to establish a stable formulation. Small amounts of organic solvents can be acceptable in certain applications of the aqueous composition, but their use brings various disadvantages. For example, material amounts of organic solvents can be detrimental to plant health, many organic solvents are VOCs and many organic solvents are hazardous and could risk contamination of eventual foodstuffs.

Without wishing to be bound by theory, the one or more essential oils might contribute to the success of the aqueous composition by serving as a repellent to pests that would otherwise attack and comprise the health of a plant. The essential oils might also contribute to the formation of an oleophilic layer that remains following evaporation of the aqueous components, which helps to retain moisture in coated plant parts and provides resistance to weathering.

The aqueous composition comprises a sugar ester, for example a sucrose ester, fructose ester, lactose ester or glucose ester. The term “sugar ester” refers to a compound derived from the esterification of a sugar and a fatty acid. As such a sugar ester contains an ester group (RCOOR′) formed between an organic acid (RCO₂H) and an alcohol (R′OH). Sugar esters are often biodegradable and have good stabilizing properties especially when incorporated in colloidal systems or emulsions.

Preferably, the sugar ester is a sucrose ester such as sucrose stearate, sucrose distearate, sucrose dilaurate, sucrose palmitate or combinations thereof. Preferably the sugar ester is sucrose stearate or sucrose distearate, which are commercially available derivatives of stearic acid. The sugar-based ester may be present in an amount of 1 to 45 wt. % based on the weight of the aqueous composition, preferably 2 to 35 wt. %, 3 to 25 wt. % or 4 to 15 wt. %, 0.1 to 7 wt. %, 0.5 to 5 wt. % or 1 to 3 wt. % based on the weight of the aqueous composition. Although some sugar esters could theoretically overlap with a dialkyl ester, a sugar ester is conceptually a different class of component from dialkyl esters for the purposes of this disclosure. As explained above, for the purposes of this disclosure, the dialkyl ester component is not intended to cover sugar esters, which are conceptually a separate class of component within the bounds of this disclosure.

The aqueous composition can further comprise a film-forming binder, such as a binding polymer. The film-forming binder is preferably a natural substance or derived from a natural substance, such as a natural wax or a carnuba wax. When present, the film-forming binder can be present in the amount of 0.5-5 wt. % based on the weight of the aqueous composition, optionally 0.5-4 wt. %, 0.75-3.5 wt. % or 1-3 wt. %.

Without wishing to be bound by theory, the film-forming binder(s) are thought to provide several advantages. Film-forming binder(s) form a protective barrier against air-based erosion from wind/grit and so on. Film-forming binder(s), especially hydrophobic binders such as waxes, are also thought to seal water in a plant, preventing excessive evaporation, which is especially valuable in seasons and/or regions of low rainfall.

The aqueous composition can also comprise a base carrier oil such as castor oil. When present, the base carrier oil can be present in the amount of 0.5-15 wt. % based on the weight of the aqueous composition, optionally 0.5-10 wt. %, 1-7 wt. % or 1-5 wt. %. The base carrier can be used to increase the volume of hydrophobic components depending on the amount of other hydrophobic components, so that a desired overall structure of the composition is attained. However, it is preferable that no base carrier is used because the carrier will not evaporate like water, so it risks washing essential oils from the leaf, thereby lowering the overall adherence of the composition.

The aqueous composition typically has a pH of 5-8, 5.5-7.5, 6-7 or 7. This can be measured by, for example, a pH probe because the majority of the aqueous composition is water. Accordingly it may be necessary to add a pH buffer to the mixture until the pH of the composition is at a desirable value. Any suitable pH buffer may be included and the skilled person will be able to select a suitable one. Preferred pH buffers include citric acid, acetic acid, carbonic acid, sodium hydroxide, Tris, HEPES or monopotassium phosphate and corresponding salts of these substances. When citric acid is used as a chelating agent, an alternative pH buffer may be required. Without wishing to be bound by theory, a pH that is neither strongly acidic nor strongly alkaline minimises the risk of plant damage when applied. Although alkaline conditions are often thought to be advantageous when treating fungi, strong alkaline conditions can risk damage to plant tissue such as leaves.

Small amounts of organic solvents can be acceptable in certain applications of the aqueous composition, but their use brings various disadvantages. For example, material amounts of organic solvents can be detrimental to plant health, many organic solvents are VOCs and many organic solvents are hazardous and could risk contamination of eventual foodstuffs. It is therefore preferable that the aqueous composition is substantially free of VOCs, e.g. less than 5 wt. % based on the total weight of the aqueous composition, or less than 4 wt. %, less than 2 wt. %, less than 0.5 wt. % or less than 0.1 wt. %.

The aqueous composition can also comprise chelating agents, including strong chelators such as polydentate and multidentate ligands. The one or more chelating agents may comprise commercially available chelators such as, but not limited to tetrasodium-N, N-Bis(carboxymethyl)-L-glutamate (GLDA), ethylenediamine-tetraacetic acid (EDTA) and ethylenediamine-N, N′-disuccinic acid (EDDS). Tetrasodium N,N-Bis(carboxymethyl)-L-glutamate (GLDA) is a preferred chelating agent because it is biodegradable and is based on L-glutamic acid which is a natural and renewable raw material. Chelating agents can be present in the aqueous composition in the amount of >0-3 wt. % based on the weight of the aqueous composition, optionally 0.5-2.5 wt. %, or 0.5-1.5 wt. %. Without wishing to be bound by theory, the addition of a chelating agent is advantageous because it can be used in conjunction with saline water without disrupting the performance of the aqueous composition. It is envisaged that including a chelating agent in the aqueous composition removes ions that could interfere with the performance of the aqueous composition. Chelating agents are known to be incompatible with agricultural compositions that rely on metals and metal ions for their activity because chelating agents can interfere with the metal complexes, ion balance with the composition and so on. However, since the present aqueous composition does not rely on metals, metal ions and metal complexes for activity, chelating agents can be used.

The skilled person will understand that the one or more chelating agents do not include sugar esters, dialkyl esters or glycosides.

The aqueous composition might further comprise thickening agents to adjust viscosity to levels desired by the user. A suitable thickener is potato starch. When present, the thickener can be present in the amount of 0.5 to 2 wt. % based on the total weight of the aqueous composition.

It is advantageous for as much of the aqueous composition to be biodegradable as possible.

It is advantageous for the composition to allow the transmission of light. This property allows the aqueous formation to result in partially or fully transparent coatings on plants, which enables future photosynthesis.

### Methods of Producing the Aqueous Composition

The aqueous composition can be produced by combining the constituent substances in a variety of ways. This flexibility is a benefit of the present invention. General speaking, it is advantageous when mixing components to do so at high mixing speeds. Without wishing to be bound by theory, it is believed that doing so helps to facilitate stable compositions when combining hydrophilic and hydrophobic components.
1. Essential oils are blended with a base oil if used.
2. Natural glucosides are added, which could act as emulsifiers for the oil phase.
3. The mixture is heated to 40 to 60° C. with constant stirring at approximately 100-300 rpm, the duration of this step is not particularly limited and can be conducted until a steady state is achieved.
4. Dimethyl glutarate, dialkyl esters and surfactants are added, followed by the gradual addition of water with rapid stirring. Any components of the composition not named in steps 1 to 3 can be added during this step.

The method may be performed at room temperature. Increasing the temperature the method is performed at may increase the speed at which the components are blended together, for example the method may be performed at any temperature within a range of 25° C. to 65° C., optionally 35° C. to 60° C., optionally 45° C. to 55° C. or 50° C.

Under some circumstances, it is envisaged that some or all of the sugar ester(s), dialkyl ester(s), dimethyl glutarate and one or more surfactants of the aqueous composition may form interlinking bonds during the method of production. The sugar ester(s), dialkyl ester(s), dimethyl glutarate and one or more surfactants in the aqueous composition are therefore intended both to cover the discrete substances or their combination through covalent or non-covalent bonds.

### Modes of Application

The aqueous composition can be used to modulate, inhibit or eradicate fungal pathogens that cause disease and other deleterious effects on various parts of agricultural crop plants (e.g., fruit, blossoms, leaves, stems, tubers, roots) or other useful plants as described herein. For example, aqueous composition may be used to modulate, inhibit or eradicate plant fungal pathogens in vegetable crops, row crops, trees, nuts, vines, turf, and ornamental plants.

The aqueous composition as described herein may be supplied or applied to a plant exogenously. The composition may be applied to the plant and/or the surrounding soil through sprays, drips, and/or other forms of liquid application.

For example, the aqueous composition as described herein can be applied to a foliar surface of a plant. Foliar applications may require 50 to 500 g per hectare of the aqueous composition as described herein. As used herein, the term “foliar surface” broadly refers to any green portion of a plant having surface that may permit absorption of silicon, including petioles, stipules, stems, bracts, flowerbuds, and leaves. Absorption commonly occurs at the site of application on a foliar surface, but in some cases, the applied composition may run down to other areas and be absorbed there.

The aqueous composition herein can be applied to the foliar surfaces of the plant using any conventional system for applying liquids to a foliar surface. For example, application by spraying will be found most convenient. Any conventional atomization method can be used to generate spray droplets, including hydraulic nozzles and rotating disk atomizers. In other instances, alternative application techniques, including application by brush or by rope-wick, may be utilized.

The aqueous composition as described herein can be directly applied to the soil surrounding the root zone of a plant. Soil applications may require 0.5 to 5 kg per hectare of the aqueous composition as described herein on a broadcast basis (rate per treated area if broadcast or banded). For example, the aqueous composition may be applied directly to the base of the plants or to the soil immediately adjacent to the plants.

The aqueous composition as provided herein may be applied to soil after planting. Alternatively, a composition as provided herein may be applied to soil during planting, or may be applied to soil before planting.

The skilled reader will appreciate that it can be convenient to dilute the aqueous composition before application to facilitate a more event distribution of the aqueous composition across the treated area (such as foliar applications that may require 50 to 500 g per hectare of the aqueous composition, or soil applications that may require 0.5 to 5 kg per hectare of the aqueous composition). A suitable dilution medium for aqueous composition is water, such as fresh water or salinated water such as seawater. A benefit of the aqueous composition is its activity at low levels when applied over a large area, such as would be encountered in the agricultural or food and drink industries.

Once applied, the aqueous component of the aqueous composition partially, substantially or fully evaporates depending on environmental conditions and time elapsed to leave behind a thin film residue of the non-aqueous components. Without wishing to be bound by theory, it is believed the residue has at least two modes of action. First, the thin film serves as a physical barrier that protects against erosion from wind, grit and so on. Film-forming components such as waxes in the aqueous composition amplify this character. Second, the components of the residual film work to break down surface tension and penetrate cells or droplets at a molecular level, removing harmful resides from the plant/soil or preventing their formation, whist removing surface calcium ionic bonds in harmful residues. Harmful residues include a variety of organisms that are harmful to plant health. Organisms of particular interest are fungi and bacteria. Notable fungi are those selected from anthracnose, botrytis, blight fungi, early blight fungi, fungi responsible for citrus canker, fungi responsible for downy mildew, fusarium, phytophthora, fungi responsible for powdery mildew, rhizoctonia, leaf spot fungi, black fungi, brown fungi and fungi responsible for crown rot. Notable bacteria are those selected from Pseudomonas aeruginosa, Escherichia coli, Staphylococcus aureus, Candida albicans, Aspergillus brasiliensis.

As a result of this treatment, a variety of desirable traits are introduced or improved. Examples of traits that may be introduced or improved include: root biomass, root length, height, shoot length, leaf number, water use efficiency, overall biomass, yield, fruit size, grain size, photosynthesis rate, tolerance to drought, heat tolerance, salt tolerance, resistance to nematode stress, resistance to a fungal pathogen, resistance to a bacterial pathogen, resistance to a viral pathogen, level of a metabolite, and proteome expression. The desirable traits, including height, overall biomass, root and/or shoot biomass, seed germination, seedling survival, photosynthetic efficiency, transpiration rate, seed/fruit number or mass, plant grain or fruit yield, leaf chlorophyll content, photosynthetic rate, root length, or any combination thereof, can be used to measure growth, and compared with the growth rate of reference agricultural plants (e.g., plants without the improved traits) grown under identical conditions.

Non-limiting examples of plants that may be treated with the aqueous composition include monocotyledonous crops such as corn, wheat, barley, rye, rice, sorghum, oat; sugarcane and turf; and dicotyledonous crops such as cotton, sugar beet, peanut, potato, sweet potato, yam, sunflower, soybean, alfalfa, canola, grapes, tobacco; vegetables including Solanaceae vegetables such as eggplant, tomato, green pepper and pepper; Cucurbitaceae vegetables such as cucumber, pumpkin, zucchini, watermelon, melon and squash; Brassicaceae vegetables such as radish, turnip, horseradish, Chinese cabbage, cabbage, leaf mustard, broccoli and cauliflower; Asteraceae vegetables such as artichoke and lettuce; Liliaceae vegetables such as leek, onion, garlic and asparagus; Apiaceae vegetables such as carrot, parsley, celery and parsnip; Chenopodiaceae vegetables such as spinach and chard; Lamiaceae vegetables such as mint and basil; flowers such as petunia, morning glory, carnation, chrysanthemum and rose; foliage plants; fruit trees such as pome fruits (e.g., apple, pear and Japanese pear), stone fruits (e.g., peach, plum, nectarine, cherry, apricot and prune), citrus (e.g., orange, lemon, lime and grapefruit), tree nuts (e.g., chestnut, pecan, walnut, hazel, almond, pistachio, cashew and macadamia), berries such as blueberry, cranberry, blackberry, strawberry and raspberry; persimmon; olive; loquat; banana; coffee; palm; coco; the other trees such tea, mulberry, flower trees, and landscape trees (e.g., ash, birch, dogwood, eucalyptus, ginkgo, lilac, maple, oak, poplar, Formosa sweetgum, sycamore, fir, hemlock fir, needle juniper, pine, spruce, yew). Non-limiting examples of the plant diseases that may be controlled by the methods described herein include diseases caused by phytopathogenic fungi (in particular of the classes of Ascomycetes, Deuteromycetes, Oomycetes and Basidiomycetes) such as Magnaporthe grisea, Cochliobolus miyabeanus, Rhizoctonia solani and Gibberella fujikuroi on rice; Erysiphe graminis, Fusarium graminearum, F. avenacerum, F. culmorum, Microdochium nivale, Puccinia striiformis, P. graminis, P. recondita, P. hordei, Typhula sp., Micronectriella nivalis, Ustilago tritici, U. nuda, Tilletia caries, Pseudocercosporella herpotrichoides, Rhynchosporium secalis, Septoria tritici, Leptosphaeria nodorum and Pyrenophora teres on wheat and barley; Diaporthe citri, Elsinoe fawcetti, Penicillium digitatum, P. italicum, Phytophthora parasitica and Phytophthora citrophthora on citrus; Monilinia mali, Valsa ceratosperma, Podosphaera leucotricha, Alternaria alternata apple pathotype, Venturia inaequalis, Colletotrichum acutatum and Phytophtora cactorum on apple; Venturia nashicola, V. pirina, Alternaria alternata Japanese pear pathotype, Gymnosporangium haraeanum and Phytophthora cactorum on pear; Monilinia fructicola, Cladosporium carpophilum and Phomopsis sp. on peach; Elsinoe ampelina, Glomerella cingulata, Uncinula necator, Phakopsora ampelopsidis, Guignardia bidwellii and Plasmopara viticola on grape; Gloeosporium kaki, Cercospora kaki and Mycosphaerella nawae on persimmon; Colletotrichum lagenarium, Sphaerotheca fuliginea, Mycosphaerella melonis, Fusarium oxysporum, Pseudoperonospora cubensis and Phytophthora sp. on Cucurbitales vegetables; Alternaria solani, Cladosporium fulvum and Phytophthora infestans on tomato; Phomopsis vexans and Erysiphe cichoracearum on eggplant; Alternaria japonica, Cercosporella brassicae, Plasmodiophora brassicae and Peronospora parasitica on Brassicaceae vegetables; Puccinia allii and Peronospora destructor on leek; Cercospora kikuchii, Elsinoe glycines, Diaporthe phaseolorum var. sojae, Phakopsora pachyrhizi and Phytophthora sojae on soybean; Colletotrichum lindemuthianum of the kidney bean; Cercospora personata, Cercospora arachidicola and Sclerotium rolfsii on peanut; Erysiphe pisi on pea; Alternaria solani, Phytophthora infestans, Phytophthora erythroseptica and Spongospora subterranean f. sp. subterranean on potato; Sphaerotheca humuli and Glomerella cingulata on strawberry; Exobasidium reticulatum, Elsinoe leucospila, Pestalotiopsis sp. and Colletotrichum theae-sinensis on tea; Alternaria longipes, Erysiphe cichoracearum, Colletotrichum tabacum, Peronospora tabacina and Phytophthora nicotianae on tobacco; Cercospora beticola, Thanatephorus cucumeris, and Aphanidermatum cochlioides on sugar beet; Diplocarpon rosae, Sphaerotheca pannosa and Peronospora sparsa on rose; Bremia lactucae, Septoria chrysanthemi-indici and Puccinia horiana on chrysanthemum and Compositae vegetables; Alternaria brassicicola on radish; Sclerotinia homeocarpa and Rhizoctonia solani on turf; Mycosphaerella fijiensis and Mycosphaerella musicola on banana; Plasmopara halstedii on sunflower; and various diseases on crops caused by Aspergillus spp., Alternaria spp., Cephalosporium spp., Cercospora spp., Cochliobolus spp., Diaporthe spp., Phomopsis spp., Diplodia spp., Fusarium spp., Gibberella spp., Helminthosporium spp., Phakopsora spp., Phytophthora spp., Blumeria spp., Oidium spp., Erysiphe spp., Uncinula spp., Podosphaera spp., Microsphaera spp., Colletotrichum spp., Corynespora spp., Peronospora spp., Plasmopara spp., Pythium spp., Pyrenophora spp., Pythium spp., Rhizoctonia spp., Rhynchosporium spp., Botryotinia spp., Botrytis spp., Botryosphaeria spp., Sphaerotheca spp., Septoria spp., Thielaviopsis spp., Typhula spp., Pseudocercosporella spp., Cochliobolus spp., Gaeumannomyces spp., Mucor spp., Puccinia spp., Tilletia spp., Ustilago spp., Venturia spp., Gymnosporangium spp., Claviceps spp., Cladosporium spp., Physalospora spp., Pyricularia spp., Magnaporthe spp., Rhizopus spp., Monilinia spp., Cladosporium spp., Curvularia spp., Sclerotinia spp., Sclerotium sp., Corticum spp., Corticium spp., Phoma spp., Polymyxa spp., and Olpidium spp.

### Application Locations

As explained above, the aqueous compositions of this disclosure can suppress the growth of problematic fungi and other unwanted organisms in the agricultural industry and food and drink industries. A benefit of the present aqueous compositions is that they can be used throughout the production process, from field to consumer, because the present aqueous compositions do not require chemicals harmful to humans for their efficacy. Furthermore, unlike compositions based on metals and metal complexes, the present compositions do not need to be removed from foodstuffs before consumption because they are generally safe for consumption. This reduces the amount of water required in the food supply chain because washing steps are reduced, which reduces the complexity and cost of processing equipment and reduces the carbon footprint of the process. Reducing or eradicating the need for this washing step is also a huge benefit when storing and transporting in arid or drought-affected locations.

As a result, the aqueous compositions can be used in a wide variety of locations. This versatility is a further benefit of the present aqueous compositions. Non-limiting locations in which the present aqueous compositions can be used are: farmland (both arable and pastoral, such as dairy, equine and poultry/turkey farms); farmhouses, barns, sheds, tool sheds, barns, pens and stalls, swine quarters, livestock farms, equine quarters, brooder houses, seed houses and veal, calving, hog, cattle and horse operations, chick vans, egg trucks, hatchery and farm vehicles; food processing plants such as meat and poultry plants; egg processing plants, poultry and turkey farms, farms, dairy farms, hog farms, meat/poultry processing plants, rendering plants, poultry and animal dressing plants, canneries, meat packing plants, hide and leather processing plants; poultry premises such as hatcheries and specific areas within such facilities, such as egg receiving areas, egg holding areas, chick holding areas, chick loading areas, setter rooms, tray dumping areas, chick processing areas, hatchery rooms, poultry buildings; processing facilities for fish, milk, citrus, wine, fruit, vegetable, ice cream and potato and beverage plants; swine premises such as farrowing barns and areas, dressing plants, stable blocks, waterers and feeders, loading equipment, creep areas, hauling equipment, nursery areas and transport chutes; food and drink establishments such as coffee shops, donut shops, bagel stores, pizza parlors, liquor stores and wineries; food handling and processing areas; and tobacco plants.

Non-limiting indicative surfaces that can be treated with the present aqueous compositions include: hatchers, setters, trays, racks, egg flats, chick boxes, egg cases, vans and trash containers, seed houses, poultry/turkey equipment, carts, sexing tables, and automated tray, rack and buggy washers, egg receiving and egg holding areas; harvesting & handling equipment; kitchen equipment such as food processors, blenders, cutlery, trash compactors and other utensils; meat packing plant surfaces such as livestock vehicles and holding pens, receiving areas and delivery chutes, slaughter areas and conveyors, hand, rub and guide rails, post knock cabinets, stands and flooring surfaces, chains and moving process lines, chutes, conveyors, tallow and animal feed production surfaces, processed product and offal equipment surfaces, fabrication and processing areas covering cold storage areas, stainless steel cut out and prep tables, and other stainless surfaces;

wine processing equipment and holding tanks; and tobacco plant equipment.

### EXAMPLES

The present invention can be further understood by reference to the following non-limiting Examples.

### Example 1: Formulation

Aqueous compositions of these Examples were produced according to the following method:
1. Essential oils are blended with a base oil if used.
2. Natural glucosides are added, which could act as emulsifiers for the oil phase.
3. The mixture is heated to 40 to 60° C. with constant stirring at approximately 100-300 rpm, the duration of this step is not particularly limited and can be conducted until a steady state is achieved.
4. Dimethyl glutarate, dimethyl succinate and surfactants are added, followed by the gradual addition of water with rapid stirring. Components of the composition not named in steps 1 to 3 were added during this step.

### Example 2: Antimicrobial Protection

The antimicrobial protection afforded by compositions of the invention were tested in accordance with BS EN ISO 11930:2019 (Criteria A). Additional details of the test protocol are as follows:

| Test Parameter | Condition/Materials Used |
|---|---|
| Test/Incubation | 22.5 ± 2.5° C. |
| temperature | |
| Test organisms | Pseudomonas aeruginosa ATCC 9027 |
| | Escherichia coli ATCC 8739 |
| | Staphylococcus aureus ATCC 6538 |
| | Candida albicans ATCC 10231 |
| | Aspergillus brasiliensis ATCC 16404 |
| Culture media | Tryptone Soy Agar (32.5 ± 2.5° C., 48 h) for |
| | bacteria |
| | Sabouraud Dextrose Agar for Candida albicans |
| | (32.5 ± 2.5° C., 48 h-72 h) |
| | Potato Dextrose Agar for Aspergillus |
| | brasiliensis (22.5 ± 2.5° C., 3-5 d) |
| Enumeration method | Pour plates |
| Neutralisation | Dilution Neutralisation using N1 Broth |
| method | |

The compositions evaluated were in accordance with the composition below:

| Component | Content (Wt. %) |
|---|---|
| Sugar ester selected from sucrose | 1-3 |
| stearate, sucrose distearate, sucrose | |
| dilaurate and/or sucrose palmitate | |
| Dimethyl glutarate | 20-30 |
| Dimethyl succinate | 10-15 |
| Dimethyl adipate | 5-10 |
| Glucosides selected from Carpryl | 2-7 |
| Glucoside, Lauryl Glucoside and | |
| Coco Glucoside | |
| Film forming component selected | 1-4 |
| from beeswax, carnuba wax | |
| Essential/Absolute oils selected from | 2-10 |
| one or more of Aloe Vera extract, | |
| Calendula extract, Caster oil, | |
| Cloverleaf essential oil, Garlic | |
| essential oil, Geranium essential oil, | |
| Lavender extract, Lemongrass | |
| essential oil, Linden extract, | |
| Peppermint essential oil, Peppermint | |
| extract, Rosemary extract, Sage | |
| extract, Thyme extract, Thyme white, | |
| Thymol, Valerian extract, Witch Hazel | |
| extract | |
| Water | Balance |

Representative data from one of the compositions tested is provided below.

Sterility Check:
Cfu/g

| Aerobic Mesophilic Bacterial Count | Yeast & Mould Count |
|---|---|
| <10 | <10 |

Neutraliser validation:

| | Recovery cfu/ml | | | | |
|---|---|---|---|---|---|
| | Pseudomonas | Staphylococcus | Escherichia | Candida | Aspergillus |
| | aeruginosa | aureus | coli | albicans | brasiliensis |
| Nvf | 1.50 × 10² | 1.49 × 10² | 1.40 × 10² | 9.7 × 10¹ | 6.9 × 10¹ |
| Inoculum Control | 1.73 × 10² | 1.61 × 10² | 1.45 × 10² | 8.9 × 10¹ | 3.7 × 10¹ |
| Control Nvn | 1.18 × 10² | 1.31 × 10² | 1.13 × 10² | 6.7 × 10¹ | 5.6 × 10¹ |

Nvf ≥ 0.5Nvn: Yes
Nv is equivalent to 0.5Nvn: Yes

Test Organism Inocula:

| | N | N₀ | | | |
|---|---|---|---|---|---|
| | Organism number in the | Organism number in the test | | | |
| | calibrated suspension | product at T0 | | | |
| Test Organism | cfu/ml | cfu/ml | Ig | Ig N₀ | Yes/No |
| Ps. aeruginosa | 8.6 × 10⁷ | 8.6 × 10⁷ | 5.93 | Between 5.00-6.00 | Yes |
| Staphylococcus aureus | 5.6 × 10⁷ | 5.6 × 10⁷ | 5.75 | Between 5.00-6.00 | Yes |
| E. coli | 7.7 × 10⁷ | 7.7 × 10⁷ | 5.89 | Between 5.00-6.00 | Yes |
| C. albicans | 5.1 × 10⁶ | 5.1 × 10⁶ | 4.71 | Between 4.00-5.00 | Yes |
| Aspergillus brasiliensis | 3.1 × 10⁶ | 3.1 × 10⁶ | 4.49 | Between 4.00-5.00 | Yes |

Number of surviving micro-organisms in the contaminated
formulation at each timepoint (Nx):

| | 7 days | | 14 days | | 28 days | |
|---|---|---|---|---|---|---|
| Test Organism | cfu/ml | lg | cfu/ml | lg | cfu/ml | lg |
| Pseud. aeruginosa | <10 | <1.0 | <10 | <1.0 | <10 | <1.0 |
| Staph. aureus | <10 | <1.0 | <10 | <1.0 | <10 | <1.0 |
| E. coli | <10 | <1.0 | <10 | <1.0 | <10 | <1.0 |
| Candida albicans | <10 | <1.0 | <10 | <1.0 | <10 | <1.0 |
| Aspergillus | | | 2.9 × 10² | 2.46 | <10 | <1.0 |
| brasiliensis | | | | | | |

Log Reduction at each timepoint (Rx):

| | | | | | Test |
|---|---|---|---|---|---|
| | 7 | 14 | 28 | | criteria |
| Test Organism | days | days | days | Pass/fail | used |
| Pseud. aeruginosa | >4.93 | NI | NI | Pass | A |
| Staph. aureus | >4.75 | NI | NI | Pass | A |
| E. coli | >4.89 | NI | NI | Pass | A |
| Candida albicans | >3.71 | NI | NI | Pass | A |
| Aspergillus brasiliensis | | 2.03 | >3.49 | Pass | A |

NI—No increase in the viable count (cfu/g)

BS EN ISO 11930: 2019 Test Criteria A:
Criteria A:

| Organism: | 7 day | 14 day | 28 day |
|---|---|---|---|
| Pseudomonas aeruginosa | ≥3 | NI | NI |
| Staphylococcus aureus | ≥3 | NI | NI |
| Escherichia coli | ≥3 | NI | NI |
| Candida albicans | ≥1 | NI | NI |
| Aspergillus brasiliensis | — | ≥0 | ≥1 |

As can be seen in the data present in this Example, the aqueous compositions of the present disclosure exhibit pronounced antimicrobial protection when tested in accordance with BS EN ISO 11930:2019 (Criteria A).

### Example 3: Comparison with Known Formulation

The aqueous compositions of the present disclosure were next compared with a prior art composition. The prior art composition chosen was sample 5 in Table 1 of US 2020/0008422. Full details of sample 5 in Table 1 of US 2020/0008422 can be found in that document, with the components of this composition summarised below for ease of reference:

| Component | Wt. % |
|---|---|
| Castor oil 36 OE | 18.0 |
| Sorbitan monolaurate 20 OE | 6.0 |
| Calcium dodecyl-benzene sulfonate | 4.0 |
| Garlic extract | 3.0 |
| 2-ethyl-1-hexanol | 2.0 |
| Propylene glycol | 8.0 |
| Deionized water | 50.0 |
| Dimethyl adipate | 1.9 |
| Dimethyl glutarate | 5.3 |
| Dimethyl succinate | 1.8 |
| Water | Balance |
| Total | 100.0 |

This composition was compared against two compositions according to the present disclosure:

| | Composition A | Composition B |
|---|---|---|
| Component | (Wt. %) | (Wt. %) |
| Sucrose stearate | 1.0 | 1.0 |
| Dimethyl glutarate | 22.5 | 28.0 |
| Dimethyl succinate | 10.0 | 15.0 |
| Dimethyl adipate | 6.0 | 5.0 |
| Carpryl Glucoside | 2.0 | 2.0 |
| Lauryl Glucoside | 2.0 | 2.0 |
| Coco Glucoside | 2.0 | 2.0 |
| Beeswax | nil | 0.5 |
| Potato starch | 0.5 | nil |
| Aloe Vera, extract | 1.0 | nil |
| Calendula extract | 0.2 | nil |
| Caster oil | 3.0 | nil |
| Cedarwood Texas | 0.5 | nil |
| essential oil | | |
| Cloverleaf essential oil | 0.5 | nil |
| Garlic essential oil | 0.5 | nil |
| Geranium essential oil | 0.5 | nil |
| Lavender extract | 0.1 | nil |
| Lemongrass essential oil | 0.5 | nil |
| Linden extract | 0.5 | nil |
| Peppermint essential oil | 0.5 | nil |
| Peppermint extract | 0.1 | nil |
| Rosemary extract | 0.1 | nil |
| Sage extract | 0.1 | nil |
| Thyme extract | 0.1 | 0.5 |
| Thyme white | 2.0 | 2.3 |
| Thymol | 2.0 | 6.5 |
| Valerian extract | 0.1 | nil |
| Witch Hazel extract | 0.1 | nil |
| Water | Balance | Balance |
| Total | 100.0 | 100.0 |

Each composition was diluted in water before testing at a ratio of 1 part composition to 25 parts water. Testing was carried out with EN 1276 Chemical disinfectants and antiseptics-Quantitative suspension test for the evaluation of bactericidal activity of chemical disinfectants and antiseptics used in food, industrial, domestic and institutional areas (Phase 2, step 1). The test organisms were Staphylococcus aureus NCTC 10788, Pseudomonas aeruginosa NCTC 6749, Escherichia coli NCTC 10538 and Enterococcus hirae NCTC 12367. The test method involved mixing 1 ml of the aggregated test bacteria with 1 ml of interfering substance (0.3 or 3 g/L albumin) and then adding 8 ml of test product. After a contact time of 5 min, 1 ml was removed and added to 9 ml of neutralizer fluid. After a period of 5 minutes neutralization, 1 ml is then plated to detect surviving test bacteria.

The results obtained were as follows:

| Composition | Prior Art | Composition A | Composition B |
|---|---|---|---|
| Mean Log10 reduction | <1.8^{Log10} | >5.8^{Log10} | >5.0^{Log10} |
| achieved across the | | | |
| four tested organisms | | | |

As demonstrated above, the compositions of the present disclosure are far more effective than a prior art composition, sample 5 in Table 1 of US 2020/0008422. Both Composition A and Composition B achieved a 5-log reduction or more, equating to a 99.999% reduction of bacteria. In contrast, sample 5 in Table 1 of US 2020/0008422 achieved a reduction of less than 1.8-log reduction

The present invention can be further understood by reference to the following paragraphs.
1. An aqueous composition comprising:
   dimethyl glutarate;
   one or more dialkyl esters;
   one or more surfactants;
   one or more essential oils; and
   one or more sugar esters;
wherein the composition is a colloid or a suspension.
2. An aqueous composition of paragraph 1, wherein dimethyl glutarate is present in the amount of 5 to 50 wt. % based on the weight of the aqueous composition, optionally 5 to 40 wt. %, 10 to 35 wt. % or 20 to 30 wt. %.
3. An aqueous composition of paragraph 1 or paragraph 2, wherein the one or more dialkyl esters are a dialkyl ester of an acid selected from succinic acid, carbonic acid, or adipic acid, preferably the dialkyl ester is dimethyl succinate, dimethyl carbonate, or dimethyl adipate, and is optionally present in an amount of 1 to 45 wt. % based on the weight of the aqueous composition, preferably 2 to 35 wt. %, 3 to 25 wt. % or 4 to 15 wt. % based on the weight of the aqueous composition.
4. An aqueous composition of any of paragraphs 1 to 3, wherein the one or more surfactants are present in the amount of 1 to 25 wt. % based on the weight of the aqueous composition, optionally 2 to 20 wt. %, 4 to 18 wt. % or 6 to 15 wt. %; optionally wherein the one or more surfactants comprise one or more glucosides, optionally one or more of a carpryl glucoside (D and/or L), a lauryl glucoside (D and/or L) or a coco glucoside (D and/or L).
5. An aqueous composition of any of paragraphs 1 to 4, wherein the one or more essential oils are present in the amount of 1 to 40 wt. % based on the weight of the aqueous composition, optionally 2 to 30 wt. %, 4 to 20 wt. % or 6 to 15 wt. %; optionally wherein the one or more essential oils comprise one or more of cedarwood essential oil, cloverleaf essential oil, garlic essential oil, geranium essential oil, lavender extract, lemongrass essential oil, linden extract, peppermint essential oil, peppermint extract, rosemary extract, sage extract, thyme extract, thyme white, thymol valerian extract, and witch hazel extract.
6. An aqueous composition of any of paragraphs 1 to 5, wherein the one or more sugar esters are a sucrose ester, fructose ester, lactose ester or glucose ester, preferably wherein the sugar ester is a sucrose ester, optionally sucrose stearate or sucrose distearate, and are optionally present in an amount of 1 to 45 wt. % based on the weight of the aqueous composition, preferably 2 to 35 wt. %, 3 to 25 wt. % 4 to 15 wt. %, 0.1 to 7 wt. %, 0.5 to 5 wt. % or 1 to 3 wt. % based on the weight of the aqueous composition.
7. An aqueous composition of any of paragraphs 1 to 6, wherein water is present in the amount of 20 to 95 wt. % based on the weight of the aqueous composition, optionally 50 to 95 wt. %, 70-95 wt. % or 80-90 wt. % based on the weight of the aqueous composition.
8. An aqueous composition of any of paragraphs 1 to 7, wherein the aqueous composition is an o/w emulsion.
9. An aqueous composition of any of paragraphs 1 to 8, further comprises a film-forming binder, optionally a natural wax.
10. An aqueous composition of any of paragraphs 1 to 9, having a pH of 5-8, 5.5-7.5, 6-7 or 7.
11. An aqueous composition of any of paragraphs 1 to 10 comprising:
   dimethyl glutarate;
   dimethyl succinate and/or dimethyl carbonate;
   one or more surfactants;
   one or more essential oils; and
   one or more sugar esters;
wherein the composition is a colloid or a suspension.
12. An aqueous composition of any of paragraphs 1 to 10 comprising:
   dimethyl glutarate;
   dimethyl succinate;
   one or more surfactants;
   one or more essential oils; and
   one or more sugar esters;
wherein the composition is a colloid or a suspension.
13. An aqueous composition of any of paragraphs 1 to 10 comprising:
   dimethyl glutarate wherein dimethyl glutarate is present in the amount of 5 to 50 wt. % based on the weight of the aqueous composition, optionally 5 to 40 wt. %, 10 to 35 wt. % or 20 to 30 wt. %;
   dimethyl succinate and/or dimethyl carbonate, present in an amount of 1 to 45 wt. % based on the weight of the aqueous composition, preferably 2 to 35 wt. %, 3 to 25 wt. % or 4 to 15 wt. % based on the weight of the aqueous composition;
   one or more surfactants;
   one or more essential oils; and
   one or more sugar esters;
wherein the composition is a colloid or a suspension.
14. An aqueous composition of any of paragraphs 1 to 10 comprising:
   dimethyl glutarate wherein dimethyl glutarate is present in the amount of 5 to 50 wt. % based on the weight of the aqueous composition, optionally 5 to 40 wt. %, 10 to 35 wt. % or 20 to 30 wt. %;
   dimethyl succinate present in an amount of 1 to 45 wt. % based on the weight of the aqueous composition, preferably 2 to 35 wt. %, 3 to 25 wt. % or 4 to 15 wt. % based on the weight of the aqueous composition;
   one or more surfactants;
   one or more essential oils; and
   one or more sugar esters;
wherein the composition is a colloid or a suspension.
15. An aqueous composition of any of paragraphs 11 to 14, wherein the one or more surfactants are present in the amount of 1 to 25 wt. % based on the weight of the aqueous composition, optionally 2 to 20 wt. %, 4 to 18 wt. % or 6 to 15 wt. %; optionally wherein the one or more surfactants comprise one or more glucosides, optionally one or more of a carpryl glucoside (D and/or L), a lauryl glucoside (D and/or L) or a coco glucoside (D and/or L).
16. An aqueous composition of any of paragraphs 11 to 15, wherein the one or more essential oils are present in the amount of 1 to 40 wt. % based on the weight of the aqueous composition, optionally 2 to 30 wt. %, 4 to 20 wt. % or 6 to 15 wt. %; optionally wherein the one or more essential oils comprise one or more of cedarwood essential oil, cloverleaf essential oil, garlic essential oil, geranium essential oil, lavender extract, lemongrass essential oil, linden extract, peppermint essential oil, peppermint extract, rosemary extract, sage extract, thyme extract, thyme white, thymol valerian extract, and witch hazel extract.
17. An aqueous composition of any of paragraphs 11 to 16, wherein water is present in the amount of 20 to 95 wt. % based on the weight of the aqueous composition, optionally 50 to 95 wt. %, 70-95 wt. % or 80-90 wt. % based on the weight of the aqueous composition.
18. An aqueous composition of any of paragraphs 11 to 17, wherein the aqueous composition is an o/w emulsion.
19. An aqueous composition of any of paragraphs 11 to 18, further comprises a film-forming binder, optionally a natural wax.
20. An aqueous composition of any of paragraphs 11 to 19, having a pH of 5-8, 5.5-7.5, 6-7 or 7.
21. An aqueous composition of any of paragraphs 11 to 20, further comprising a chelator, optionally selected from tetrasodium-N,N-Bis(carboxymethyl)-L-glutamate ethylenediamine-tetraacetic (GLDA), acid (EDTA) and ethylenediamine-N,N′-disuccinic acid (EDDS), optionally present in the aqueous composition the amount of >0-3 wt. % based on the weight of the aqueous composition, optionally 0.5-2.5 wt. %, or 0.5-1.5 wt. %.
22. Use of a composition as defined in any of paragraphs 11 to 21 in a method of protecting a surface by contacting the surface with an aqueous composition as defined in any of paragraphs 1 to 22, optionally wherein the surface is the surface of vegetation, foodstuff or soil.
23. The use of paragraph 22, wherein the surface is one or more of a leaf, green stem, soil or one or more items of food.
24. A method of transporting and/or storing one or more food items, comprising contacting the surface of one or more food items with an aqueous composition according to any one of paragraphs 1 to 21 before or during transport and/or storage.
25. A method of solvating a substance, comprising contacting the substance with the aqueous composition as defined in any of paragraphs 1 to 21.
26. A surface coated with composition as defined in any of paragraphs 1 to 21, optionally wherein the surface is part or all of a plant, soil, part or all of a food stuff or part or all of a container for storing plants, harvested plants or foodstuffs.
27. An aqueous composition according to any of paragraphs 1 to 21 comprising: dimethyl glutarate;
   one or more dialkyl esters other than dimethyl glutarate and which is not a sugar ester;
   one or more surfactants comprising a glycoside or a combination of glycosides;
   one or more essential oils; and
   one or more sugar esters derived from the esterification of a sugar and a fatty acid;
wherein the composition is a colloid or a suspension,
wherein the biocidal aqueous composition achieves a mean reduction of >5^{Log10} in viable bacteria within 5 minutes.
28. The aqueous composition of paragraph 27, wherein the composition achieves a mean reduction of >5^{Log10} in viable bacteria within 3 minutes.
29. The aqueous composition of paragraph 27, wherein the composition achieves a mean reduction of >5^{Log10} in viable bacteria within 1 minute.
30. The aqueous composition of any of paragraphs 27 to 29, wherein the viable bacteria is at least one of Pseudomonas aeruginosa, Staphylococcus aureus, Escherichia coli, and Enterococcus hirae.
31. Use of a composition as defined in any of paragraphs 27 to 30 in a method of protecting a surface by contacting the surface with an aqueous composition as defined in any of paragraphs 27 to 30, optionally wherein the surface is the surface of vegetation, foodstuff or soil.
32. Use of a composition as defined in any of paragraphs 27 to 30 in a method of protecting a surface by contacting the surface with an aqueous composition as defined in any of paragraphs 27 to 30, optionally wherein the surface is the surface of vegetation, foodstuff or soil.
33. The use of paragraph 32, wherein the surface is one or more or a leaf, green stem, soil or one or more items of food.
34. A method of transporting and/or storing one or more food items, comprising contacting the surface of one or more food items with an aqueous composition according to any of paragraphs 27 to 30 before or during transport and/or storage.
35. A method of solvating a substance, comprising contacting the substance with the aqueous composition as defined in any of paragraphs 27 to 30.

1. An aqueous composition comprising:
dimethyl glutarate;
one or more dialkyl esters other than dimethyl glutarate and which is not a sugar ester;
one or more surfactants comprising a glycoside or a combination of glycosides;
one or more essential oils; and
one or more sugar esters derived from the esterification of a sugar and a fatty acid;
wherein the composition is a colloid or a suspension.

2. The aqueous composition of claim 1, wherein dimethyl glutarate is present in the amount of 5 to 50 wt. %, 5 to 40 wt. %, 10 to 35 wt. % or 20 to 30 wt. % based on the weight of the aqueous composition.

3. The aqueous composition of claim 1, wherein the one or more dialkyl esters are a dialkyl ester of an acid selected from succinic acid, carbonic acid, or adipic acid, preferably the dialkyl ester is dimethyl succinate, dimethyl carbonate, or dimethyl adipate.

4. The aqueous composition of claim 1, wherein the one or more dialkyl esters is present in an amount of 1 to 45 wt. %, 2 to 35 wt. %, 3 to 25 wt. % or 4 to 15 wt. % based on the weight of the aqueous composition.

5. The aqueous composition of claim 1, wherein the one or more surfactants are present in the amount of 1 to 25 wt. %, 2 to 20 wt. %, 4 to 18 wt. % or 6 to 15 wt. % based on the weight of the aqueous composition.

6. The aqueous composition of claim 1, wherein the one or more surfactants comprise one or more glucosides, optionally one or more of a carpryl glucoside (D and/or L), a lauryl glucoside (D and/or L) or a coco glucoside (D and/or L).

7. The aqueous composition of claim 1, wherein the one or more essential oils are present in the amount of 1 to 40 wt. %, 2 to 30 wt. %, 4 to 20 wt. % or 6 to 15 wt. % based on the weight of the aqueous composition;
wherein the one or more essential oils comprise one or more of cedarwood essential oil, cloverleaf essential oil, garlic essential oil, geranium essential oil, lavender extract, lemongrass essential oil, linden extract, peppermint essential oil, peppermint extract, rosemary extract, sage extract, thyme extract, thyme white, thymol valerian extract, and witch hazel extract.

8. The aqueous composition of claim 1, wherein the one or more sugar esters are a sucrose ester, fructose ester, lactose ester or glucose ester, wherein the sugar ester is a sucrose ester, sucrose stearate, or sucrose distearate, and wherein the one or more sugar esters are present in an amount of 1 to 45 wt. %, 2 to 35 wt. %, 3 to 25 wt. % or 4 to 15 wt. %, 0.1 to 7 wt. %, 0.5 to 5 wt. % or 1 to 3 wt. % based on the weight of the aqueous composition.

9. The aqueous composition of claim 1, wherein water is present in the amount of 20 to 95 wt. % based on the weight of the aqueous composition, optionally 50 to 95 wt. %, 70-95 wt. % or 80-90 wt. % based on the weight of the aqueous composition.

10. The aqueous composition of claim 1, wherein the aqueous composition is an o/w emulsion.

11. The aqueous composition of claim 1, further comprises a film-forming binder, optionally a natural wax.

12. The aqueous composition of claim 1, having a pH of 5-8, 5.5-7.5, 6-7 or 7.

13. A method of protecting a surface, the method comprising contacting the surface with the aqueous composition of claim 1; wherein the surface is the surface of vegetation, foodstuff, or soil.

14. The method of claim 13, wherein the surface is one or more or a leaf, green stem, soil or one or more items of food.

15. A method of transporting and/or storing one or more food items, comprising contacting surface of the one or more food items with an aqueous composition according to claim 1 before or during transport and/or storage.

16. A method of solvating a substance, comprising contacting the substance with the aqueous composition as defined in claim 1.

17. An aqueous composition comprising:
dimethyl glutarate;
one or more dialkyl esters other than dimethyl glutarate and which is not a sugar ester;
one or more surfactants comprising a glycoside or a combination of glycosides;
one or more essential oils; and
one or more sugar esters derived from the esterification of a sugar and a fatty acid;
wherein the composition is a colloid or a suspension,
wherein the aqueous composition achieves a mean reduction of >5^{Log10} in viable bacteria within 5 minutes.

18. The aqueous composition of claim 17, wherein the composition achieves a mean reduction of >5^{Log10} in viable bacteria within 3 minutes.

19. The aqueous composition of claim 17, wherein the composition achieves a mean reduction of >5^{Log10} in viable bacteria within 1 minutes.

20. The aqueous composition of claim 17, wherein the viable bacteria is at least one of Pseudomonas aeruginosa, Staphylococcus aureus, Escherichia coli, and Enterococcus hirae.
